(19) United States
(12) Patent Application Publication
(10) Pub. No.: US 2021/0392202 A1
(43) Pub. Date: Dec. 16, 2021

(54) ARTIFICIAL INTELLIGENCE LOG PROCESSING AND CONTENT DISTRIBUTION NETWORK OPTIMIZATION

(71) Applicant: Level 3 Communications, LLC, Broomfield, CO (US)

(72) Inventors: William R. Henning, Prairieville, LA (US); Steven M. Casey, Littleton, CO (US); Todd A. Borchert, Parker, CO (US)

(73) Assignee: Level 3 Communications, LLC, Broomfield, CO (US)

(21) Appl. No.: 17/342,138

(22) Filed: Jun. 8, 2021

Related U.S. Application Data
(60) Provisional application No. 63/037,808, filed on Jun. 11, 2020.

(51) Int. Cl. H04L 29/08; H04L 12/24

(52) U.S. Cl. CPC H04L 67/327; H04L 41/145; H04L 67/1002

(57) ABSTRACT

Examples of the present disclosure relate to artificial intelligence log processing and CDN optimization. In examples, log data is processed at a node of the CDN rather than transmitting all of the log data for remote processing. The log data may be processed by a model processing engine according to a model, thereby generating model processing results. Model processing results are communicated to a parent node, thereby providing insight into the state of the node without requiring transmission of the full set of log data. Model processing results and associated information may be used to alter the configuration of the CDN. For example, a model processing engine may be added or removed from a node based on a forecasted amount of log data. As another example, edge servers of a node may be added or removed based on expected computing demand.

### CROSS-REFERENCE TO RELATED APPLICATIONS

This application claims the benefit of U.S. Provisional Application No. 63/037,808, filed Jun. 11, 2020, the complete disclosure of which is hereby incorporated herein by reference in its entirety.

### BACKGROUND

A content distribution network (CDN) comprises one or more gateway nodes and associated edge servers. The edge servers may generate a large amount of log data, such that it is infeasible to aggregate all of the log data from edge servers of the CDN at a remote location. Thus, certain log data may be unavailable for processing, which may complicate log analysis and the identification of potential performance optimization strategies.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure relate to artificial intelligence log processing and content distribution network (CDN) optimization. In examples, log data of a CDN node is processed at the node rather than transmitting all of the log data for remote or centralized processing. The log data may be processed by a model processing engine according to one or more models in order to generate one or more model processing results. Model processing results and, in some examples, additional information relating to such results (e.g., a relevant set of log data, machine identifiers, etc.), are communicated to a parent node within the CDN, thereby providing insight into the state of the node without requiring transmission of the full set of log data.

Model processing results and associated information may be used to alter the configuration of the CDN. For example, a model processing engine may be added or removed from a node of the CDN responsive to the amount of log data that is forecasted. As another example, edge servers of a node may be added or removed based on expected demand from services and client computing devices. As a result, conclusions may be drawn based on log data that would not otherwise be available for remote processing, and resources of the CDN may be more efficiently allocated in response to changing conditions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A illustrates an overview of an example system in which aspects of artificial intelligence log processing and CDN optimization are performed.

FIG. 1B illustrates an overview of an example CDN in which aspects of the present disclosure may be performed.

FIG. 2A illustrates an overview of an example method for processing log data at a node based on a model according to aspects described herein.

FIG. 2B illustrates an overview of an example method for aggregating and processing models within a CDN according to aspects described herein.

FIG. 2C illustrates an overview of an example method for generating a model based on service log data and CDN log data according to aspects described herein.

FIG. 3A illustrates an overview of an example method for adapting model processing engines of a CDN based on a forecast according to aspects described herein.

FIG. 3B illustrates an overview of an example method for adapting a number of edge servers of a CDN based on a forecast according to aspects described herein.

FIG. 4 illustrates an example of a suitable operating environment in which one or more of the present embodiments may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A content distribution network (CDN) comprises a set of edge servers used to process requests from client computing devices. In examples, edge servers of the CDN are grouped to form a node within the CDN. For example, the CDN may have a hierarchical structure, in which a gateway node comprises a set of edge servers and multiple gateway nodes are managed by a regional node (which may also comprise a set of edge servers). Similarly, one or more regional nodes may be managed by a global node. Accordingly, child nodes (and edge servers therein) may be configured (directly or indirectly) by parent nodes of the CDN. Additionally, log data generated by child nodes may be aggregated by a parent node for analysis (e.g., by the parent node, by a grandparent node, etc.).

However, remotely aggregating all or even a large subset of the log data generated by a node may be difficult, for example, in instances where there are many edge servers associated with the node and/or where there are a high number of requests from client computing devices, among other examples. In such examples, log data may instead be sampled, such that only a subset of the log data is aggregated. For example, log data may be sampled according to a population of client computing devices (e.g., associated with a geographic location, a service, a device type, etc.), a service that is a customer of the CDN, and/or a type of computing functionality, among other examples. While sampling log data reduces challenges associated with aggregating the log data, it may also limit the utility of the log data. For example, it may be difficult or impossible to analyze the sampled log data to diagnose issues, improve CDN performance, and/or reduce computational inefficiencies, especially in instances where it is unclear which specific subset of log data is useful or necessary in order to perform such analyses.

Accordingly, aspects of the present disclosure relate to artificial intelligence log processing and CDN optimization. In examples, a node of the CDN comprises a model processing engine, which processes log data that is generated within the node. Thus, rather than remotely aggregating only a subset of the log data from a node, the log data may instead be processed locally at the node according to one or more models. Model processing results that are generated according to such models may then be communicated to a parent node, thereby providing insight about the node to other nodes within the CDN without requiring transmission of the entire set of log data across the CDN.

In examples, a CDN is used by a service (e.g., a customer of the CDN) to process requests of client computing devices associated with users of the service. Any of a variety of services may use a CDN according to aspects described herein. Example services include, but are not limited to, a video streaming service, a video game service, a cloud-computing service, or a web application service. For example, a video streaming service may use the CDN to provide streaming content, thereby offloading at least a part of the computational demand associated with providing the video streaming service to the CDN. As another example, the video game service may use the CDN to distribute game updates and/or perform server-side processing, among other examples. Thus, it will be appreciated that a service may use a CDN for any of a variety of computing functionality, including, but not limited to, providing content (e.g., one or more files, video and/or audio streams, etc.), server-side processing (e.g., online gaming, cloud computing, web applications, etc.), and audio/video conferencing, among other examples.

As used herein, log data includes, but is not limited to, information relating to system performance (e.g., resource utilization, requests per second, etc.), system errors (e.g., hardware failures, software stack traces, request timeouts, etc.), CDN cache performance (e.g., hit ratio, miss ratio, etc.), and/or requests from client computing devices (e.g., a requested resource, a device type, a source Internet Protocol (IP) address, an associated service, etc.). Thus, it will be appreciated that log data may relate to key performance indicators, metrics, telemetry, fault information, and/or performance information. In examples, at least a part of the log data for the node is generated by one or more edge servers and/or networking devices (e.g., a router, a switch, a firewall device, a load balancer, etc.).

In addition to, or as an alternative to, log data generated by a node of a CDN, a service may also generate service log data, which may be provided to the CDN. For example, the service may provide log data gathered by a client-side application or generated by a website of the service. As an example, if the service is a video streaming service, the service log data may relate to a buffering event, playback statistics, and/or requested content from the CDN, among other examples. In some examples, service log data is processed in combination with CDN log data, thereby correlating events of the CDN log data with events of the service log data to generate a model processing result according to aspects described herein.

Any of a variety of models may be used to analyze log data, including, but not limited to, a machine learning model or a statistical model. For example, log data may be processed to generate a statistical model that may then be used to evaluate subsequent log data. The statistical model may identify one or more thresholds or ranges that are indicative of normal or routine behavior (e.g., relating to resource utilization, requests per second, cache performance, time to process a request, etc.), such that subsequent log data that exceeds such a threshold or range is classified accordingly. As another example, a machine learning model may be generated using annotated log data, thereby enabling the subsequent classification of log data based on the machine learning model. In some instances, the machine learning model is trained using both CDN log data and service log data, thereby enabling the prediction of events indicated by the service log data based on the CDN log data (e.g., without using the service log data). It will be appreciated that example machine learning techniques are described herein and that any of a variety of supervised and unsupervised machine learning techniques may be used.

In some examples, multiple models are used to analyze the log data. For example, results from a set of models are compared to identify a model processing result having the highest confidence. In some instances, model performance is tracked over time, thereby enabling multiple models to be ranked according to one or more model performance metrics (e.g., prediction accuracy, average confidence score, etc.). Further, a model may be associated with a specific service, computing functionality, or other instance in which the model should be used to process log data. Thus, the model need not be used to process log data in all instances, but may instead by associated with one or more specific instances in which the model is well-suited to process such log data.

In examples, a model is shared among nodes of a CDN. For example, a model used by a first node may be provided to a second node for the second node to process log data accordingly. In some examples, the model of the first node is identified as an appropriate model for the second node based on determining that the first node and the second node share one or more similar characteristics. Example characteristics include, but are not limited to, a geographic location (e.g., of a population of client computing devices served by a node, of a node itself, etc.), a type of computing functionality provided by the node, and/or one or more services that are associated with the node. In some examples, the second node may then refine the model according to aspects described herein. As such, the second node is provided with a model that is likely to be well-suited for the log data generated at the node, rather than requiring that a new model be generated for the second node.

As discussed above, log data is processed using one or more models in order to generate a model processing result. Example model processing results include, but are not limited to, the identification of a performance bottleneck, the identification of a hardware or software issue, and/or a forecasted level of resource utilization. In examples, a single entry within the log data may not be sufficient to make a specific determination, but one or more models described herein may be used to identify a pattern or a set of entries that exceeds a threshold/range, thereby generating a model processing result accordingly.

In examples, such model processing results are communicated to one or more other nodes within the CDN. As an example, a reporting engine of a node may receive the model processing results and use the model processing results to generate a report. In some examples, at least a subset of the log data associated with the model processing result is communicated in conjunction with the model processing result. It will be appreciated that other information may be communicated in addition to or as an alternative to the subset of log data, including, but not limited to, an identifier associated with the computing device and/or the node for which the model processing result was made, a model used to generate the model processing result, and/or a confidence score associated with the model processing result.

The model processing result and associated information may be stored. As an example, the model processing result may be stored for subsequent analysis in order to evaluate the strength or effectiveness of a model, to adapt the configuration of one or more nodes of the CDN, and/or to generate reports. For example, it may be determined that an additional model processing engine should be added to a node, as may be the case when an existing model processing engine is operating at or near capacity (e.g., with respect to network bandwidth, processor capabilities, and/or memory availability, etc.). As another example, it may be determined that additional edge servers should be added or that existing edge servers should be powered off according to forecasted demand. Additional actions include remedying an identified bottleneck (e.g., by adding more edge servers, by reconfiguring network devices, etc.), restarting or replacing a failing edge server, and/or reimaging a virtual machine, among other examples. Such operations may be performed automatically by communicating with a node to instruct the node to instantiate or un-instantiate hardware devices and/or virtual machines. Thus, while examples are described herein with respect to a “server,” it will be appreciated that the server need not be a hardware device and may instead be a virtual machine.

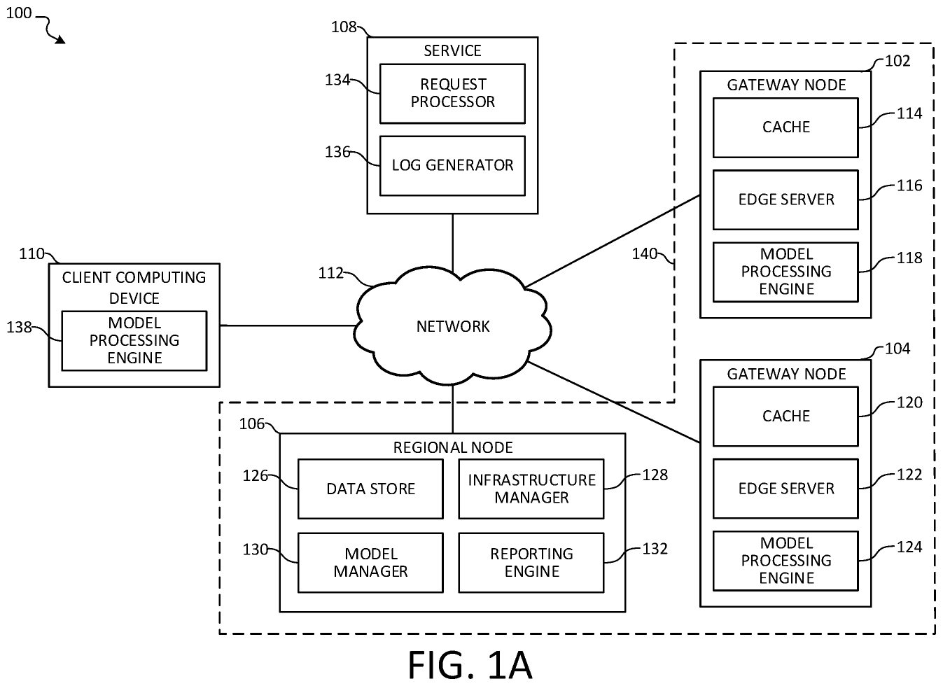

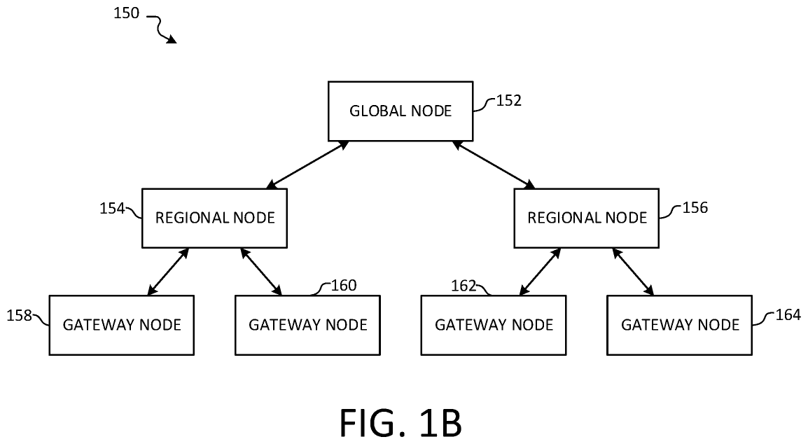

FIG. 1A illustrates an overview of an example system 100 in which aspects of artificial intelligence log processing and CDN optimization are performed. As illustrated, system 100 comprises gateway node 102, gateway node 104, regional node 106, service 108, client computing device 110, and network 112. Gateway node 102, gateway node 104, regional node 106, service 108, and client computing device 110 are illustrated communicating through network 112. Network 112 may comprise a local area network, a wide area network, one or more cellular networks, and/or the Internet, among other examples.

Service 108 may be any of a variety of services, including, but not limited to, a video streaming service, a video game service, a cloud-computing service, or a web application service, among other examples. Service 108 may use a CDN (e.g., comprising gateway nodes 102 and 104 and regional node 106, as illustrated by dashed box 140) to provide at least a part of the computing functionality utilized by client computing device 110. It will be appreciated that, in other examples, certain elements of the example CDN described with respect to system 100 may be provided by a third party and/or functionality described herein with respect to specific elements may be distributed according to any of a variety of other techniques.

Service 108 is illustrated as comprising request processor 134 and log generator 136. In examples, request processor 134 of service 108 processes requests received from client computing device 110. For example, request processor 134 may direct client computing device 110 to a node of the CDN (e.g., one of nodes 102, 104, or 106), for example in response to a request for content (and/or other computing functionality) for which service 108 uses the CDN. In examples, log generator 136 generates service log data according to aspects described herein. For example, when a request is received by service 108 from client computing device 110, log generator 136 generates service log data based on the request (e.g., comprising information about the received request, about processing performed by request processor 134, etc.). It will be appreciated that, in some examples, client computing device 110 comprises a log generator that provides log data to service 108, such that at least a part of the log data is incorporated into the service log data generated by log generator 136.

Client computing device 110 may be any of a variety of computing devices, including, but not limited to, a mobile computing device, a tablet computing device, a laptop computing device, or a desktop computing device. In examples, client computing device 110 communicates with service 108 and/or one or more nodes of CDN 140. Client computing device 110 is illustrated as comprising model processing engine 138, as, in some examples, log data generated by client computing device 110 may be processed locally by model processing engine 138 according to aspects described herein. Model processing results generated by model processing engine 138 may then be communicated to CDN 140 (e.g., to a node with which client computing device 110 is communicating, via service 108, etc.). Although one client computing device 110 is illustrated, it is understood that multiple (and possibly a large number) of client computing devices 110 are contemplated by the current methods and systems.

Gateway node 102 is illustrated as comprising cache 114, edge server 116, and model processing engine 118. In examples, cache 114 stores content associated with service 108, which is provided to client computing device 110. Edge server 116 provides computing functionality of the CDN according to aspects described herein. For example, edge server 116 accesses content from cache 114 or otherwise obtains the content and provides the content to client computing device 110. Gateway node 102 is illustrated as further comprising model processing engine 118. In examples, devices of gateway node 102 generate CDN log data, such as cache 114, edge server 116, and/or any of a variety of other networking devices (not pictured).

Model processing engine 118 processes such log data based on one or more models as described herein. For example, model processing engine 118 may process the log data in order to generate a statistical model, which may then be used to evaluate subsequent log data. The statistical model may identify one or more thresholds or ranges that are indicative of normal or routine behavior for gateway node 102, such that subsequent log data that exceeds such a threshold or range is classified accordingly. As another example, model processing engine 118 uses a machine learning model (e.g., generated according to unsupervised or supervised techniques and/or iteratively refined using CDN log data and/or service log data from service 108). For example, model processing engine 118 uses a machine learning model that was generated based at least in part on service log data to process CDN log data generated by one or more devices of gateway node 102. In some examples, model processing engine 118 provides one or more models to regional node 106 and/or receives such models from regional node 106.

Similar to gateway node 102, gateway node 104 is illustrated as comprising cache 120, edge server 122, and model processing engine 124. Such aspects are similar to those described above with respect to gateway node 102 and are therefore not re-described in detail. In examples, a model generated by model processing engine 118 of gateway node 102 is provided to and subsequently used by model processing engine 124 via regional node 106. While gateway nodes 102 and 104 are each illustrated as comprising a single edge server (edge servers 116 and 122, respectively), it will be appreciated that any number of edge servers may be used in a gateway node. Additionally, a gateway node need not comprise a model processing engine. Rather, in other examples, a model processing engine of one node may process log data for one or more other nodes. As an example, model processing engine 124 may be omitted, such that model processing engine 118 of gateway node 102 is used to process log data from gateway node 104. Gateway nodes 102 and 104 may be geographically distributed in order to improve latency between the nodes and client computing devices.

System 100 further comprises regional node 106. Regional node 106 is illustrated as comprising data store 126, infrastructure manager 128, model manager 130, and reporting engine 132. In some examples, regional node 106 may further comprise elements similar to gateway nodes 102 and 104, such as one or more caches, edge servers, and/or model processing engines. In examples, regional node 106 manages gateway nodes 102 and 104. For example, regional node 106 aggregates model processing results relating to log data from gateway nodes 102 and 104 according to aspects described herein, which may be stored in data store 126. As discussed above, model processing results received from gateway nodes 102 and 104 may comprise at least a subset of the log data associated with the model processing result. In another example, other information may be communicated in addition to or as an alternative to the subset of log data, including, but not limited to, an identifier associated with the gateway node and/or a device in the gateway node, a model used to generate the model processing result, and/or a confidence score associated with the model processing result.

As another example, infrastructure manager 128 may configure aspects of gateway nodes 102 and 104 based at least in part on the received model processing results stored in data store 126. In examples, infrastructure manager 128 processes model processing results stored in data store 126 using one or more models to determine whether to add or remove edge servers, caches, and/or model processing engines of gateway nodes 102 and 104. Thus, the processing requirements of the CDN may be forecasted according to data received by regional node 106 in order to more efficiently utilize computing resources of the CDN (e.g., of gateway nodes 102 and 104) to service forecasted demand (e.g., by service 108 and client computing device 110). As another example, if it is determined that both model processing engines 118 and 124 are underutilized, one model processing engine may be shut down in favor of the other model processing engine. As another example, infrastructure manager 128 may add another model processing engine to the CDN if it is determined that the amount of log data at one of gateway nodes 102 or 104 is such that model processing engine 118 or 124, respectively, is unsuited to process the log data (e.g., contemporaneously, within a certain time period, etc.). As discussed above, adding another model processing engine may comprise powering on an unused hardware device or instantiating a virtual machine as a model processing engine, among other examples.

Regional node 106 is further illustrated as comprising model manager 130. In examples, model manager 130 receives models from gateway nodes 102 and 104 (e.g., as may have been generated by model processing engine 118 and 124, respectively). Model manager 130 may also provide models to gateway nodes 102 and 104, which may be used by model processing engines 118 and 124, respectively, to process log data accordingly. Models received by model manager 130 may be stored by data store 126. In examples, model manager 130 evaluates a set of models according to any of a variety of model performance metrics, including, but not limited to, prediction accuracy or average confidence score. In some instances, model manager 130 determines a set of models based on models from nodes having similar attributes. For example, nodes having a similar geographic location, similar computing functionality, and/or that provide computing functionality for the same service or similar services.

Accordingly, model manager 130 may compare models for similar nodes in order to determine whether one model is better than another model (e.g., according to one or more model performance metrics). As a result of such a comparison, model manager 130 may transmit the model to a model processing engine of a node, such that the model processing engine may use the model to evaluate log data of the node. In some examples, model manager 130 may select one or more models to provide to a model processing engine that does not have any models with which to process log data (e.g., as may be the case for a new node or for a model processing engine that was just instantiated by infrastructure manager 128). Alternatively, model manager 130 may select one or more models to a model processing engine to replace an existing model. It will be appreciated that any of a variety of additional or alternative model performance metrics may be used to evaluate the performance of a model according to aspects described herein.

Regional node 106 is further illustrated as comprising reporting engine 132, which processes model processing results stored by data store 126 to generate reports. Example reports include, but are not limited to, reports relating to model performance, node performance (e.g., for a node overall, for one or more devices of a node, etc.), and/or anomalous behavior (e.g., of a device of a node, of demand from a population of client computing devices, etc.). In examples, reporting engine 132 may generate alerts based on such reports (e.g., via email, via a text message, via simple network management protocol (SNMP), etc.). In other examples, any of a variety of other reports may be generated by reporting engine 132 based on aggregated model processing results from gateway nodes 102 and/or 104.

FIG. 1B illustrates an overview of an example CDN 150 in which aspects of the present disclosure may be performed. As illustrated, example CDN 150 comprises global node 152, regional nodes 154 and 156, and gateway nodes 158, 160, 162, and 164. As described above, regional node 154 may manage gateway nodes 158 and 160, while regional node 156 may manage gateway nodes 162 and 164. Thus, rather than managing all four gateway nodes 158-164 from a centralized location, management of nodes 158-164 is distributed between regional nodes 154 and 156. Similarly, global node 152 may manage regional nodes 154 and 156. In examples, a configuration received by regional nodes 154 and 156 from a parent node (e.g., global node 152) may be forwarded or otherwise communicated to child nodes accordingly. Any of a variety of other configurations may be used for a CDN without departing from aspects of the present disclosure. For example, a hierarchy need not have three levels, but may instead have fewer or additional levels. Additionally, a node need not have one parent node or two child nodes, but may have any number of such nodes. As another example, a hierarchy need not be used.

Model processing results and associated information may be aggregated at parent nodes according to aspects described herein. For example, log events of gateway nodes 158 and 160 may be processed by a model processing engine of one of gateway nodes 158 or 160. In example, a model processing engine is local to each of gateway nodes 158 and 160. Model processing results by the model processing engine may be communicated to regional node 154 accordingly. Similarly, log data of gateway nodes 162 and 164 may be processed by a model processing engine (e.g., each of gateway nodes 162 and 164 may have a model processing engine, there may be only one model processing engine for both nodes, etc.), after which the model processing results may be aggregated by regional node 156. Processed log data of regional nodes 154 and 156 (and model processing results of child nodes 158-164) may be similarly aggregated by global node 152.

In addition to the aggregation of model processing results and associated log data, models may be shared among nodes according to aspects described herein. For example, gateway node 158 may provide a model to regional node 154, which may be provided to gateway node 160. Similarly, a model from regional node 154 may be provided to regional node 156 via global node 152. In some examples, the model may be the model received from gateway node 158, thereby enabling models to be shared between multiple levels of the hierarchy of example CDN 150. Thus, it will be appreciated that models may be shared among any of a variety of nodes within a CDN.

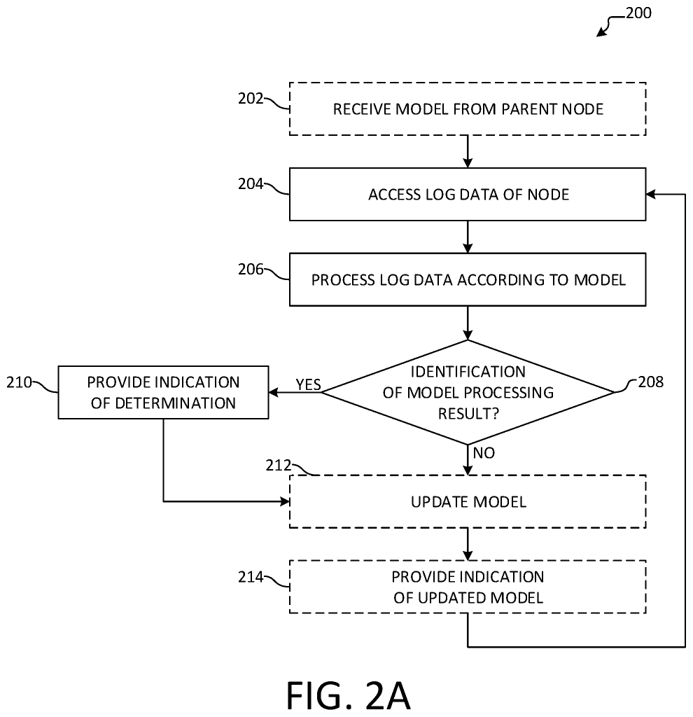

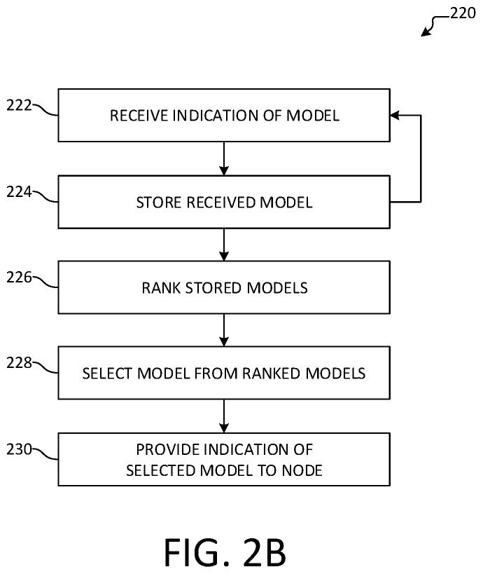

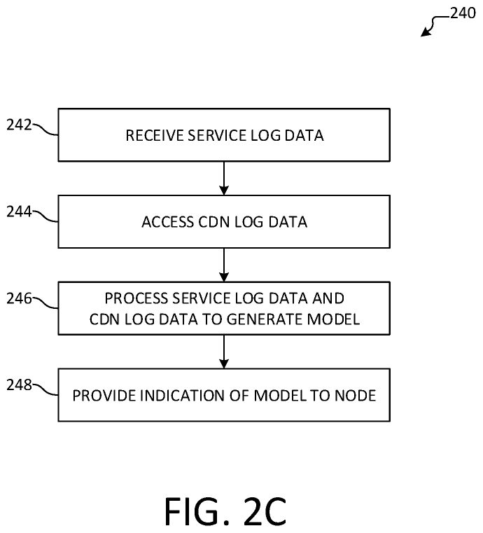

FIG. 2A illustrates an overview of an example method 200 for processing log data at a node based on a model according to aspects described herein. In examples, aspects of method 200 are performed by a model processing engine, such as model processing engine 118 or 124 in FIG. 1A. Method 200 begins at operation 202, where a model is received from a parent node. In examples, the model is received from a model manager of the parent node, such as model manager 130 in FIG. 1. The parent node may a regional node or a global node, such as regional node 154 or 156, or global node 152 in FIG. 1B. Operation 202 is illustrated using a dashed box to indicate that, in other examples, operation 202 may be omitted, as may be the case where a preexisting model is used (e.g., as may have been generated at the node itself, as may have been previously received from another node, etc.).

At operation 204, log data is accessed. As described above, the log data may be CDN log data relating to one or more devices of the node, such as a cache (e.g., cache 114 or 120 in FIG. 1A), an edge server (e.g., edge server 116 or 122), or one or more network devices, among other computing devices. In examples, the log data accessed at operation 204 may comprise service log data that is received or otherwise accessed from a service, such as service 108 in FIG. 1A. Thus, the log data accessed at operation 204 may be CDN log data and/or service log data. As described above, the log data may comprise information relating to system performance, system errors, cache performance, and/or requests from client computing devices, among other data. The accessed log data need not be for the node at which the model processing engine is located, as may be the case where one node processes log data for one or more other nodes.

Flow progresses to operation 206, where the log data is processed according to a model. In examples, the model was received at operation 202, as discussed above. In other examples, a preexisting model is used (e.g., as may have been previously received from a parent node or generated at the node, among other examples). According to aspects described herein, the model may be a statistical model, a machine learning model, or any of a variety of other models. It will be appreciated that while method 200 is described as processing the log data using a single model, other examples may comprise using multiple models to process the log data. For example, a set of models is used to process the log data, after which the performance of each model is compared (e.g., according to one or more model performance metrics) in order to select a model processing result accordingly.

At determination 208, it is determined whether a model processing result is identified. In examples where a statistical model is used, the processed log data may be compared to a predetermined threshold or a range, among other examples. In other examples, a classification generated by a machine learning model is compared to a set of classifications for which an indication should be generated and provided to a parent node. For example, the set of classifications may be specified by the parent node or may have been generated by the node itself (e.g., according to historical data). As described above, example model processing results include, but are not limited to, the identification of a performance bottleneck, the identification of a hardware or software issue, and/or a forecasted level of resource utilization. Thus, the model processing result, if identified, indicates a determination relating to the node of the CDN that was generated as a result of processing the log data according to the model.

If a model processing result is identified, flow branches “YES” to operation 210, where an indication of the model processing result is provided. In examples, the indication comprises the model processing result and other information relating to the model processing result, including, but not limited to, a subset of log data that is determined to be relevant to the model processing result (e.g., as was processed at operation 206), an identifier associated with a computing device and/or the node for which the model processing result was made, a model used to generate the model processing result, and/or a confidence score associated with the model processing result. The indication may be provided to a parent node, such as a regional node (e.g., regional node 154 or 156 in FIG. 1B) or a global node (e.g., global node 152). Flow then progresses to operations 212 and 214, which are discussed below. Operations 212 and 214 are illustrated using a dashed box to indicate that, in other examples, they may be omitted. In such examples, flow instead returns to operation 204 where additional log data is processed, such that flow loops between operations 204-210.

If, however, no model processing result is identified, flow instead branches “NO” to operation 212, where the model is updated. In examples, a statistical model is updated to reflect changes in resource utilization, requested content, and/or other changes that may occur over time, thereby adapting the model to the current state of the CDN. For example, a moving average may be used, or the model may be updated to account for changes that are seasonal, daily, or that occur according to any of a variety of other schedules. As another example, a machine learning model is updated based on the log data processed at operation 206 (and any subsequent model processing result at operations 208-210), as may be the case when unsupervised machine learning is used.

At operation 214, an indication of the updated model is provided to a parent node, such as a regional node (e.g., regional node 154 or 156 in FIG. 1B) or a global node (e.g., global node 152). As described above, the updated model may be provided to a model manager, such as model manager 130 in FIG. 1A. In examples, the indication comprises information relating to the model, such as one or more confidence scores and/or historical model performance, among other examples. Flow then return to operation 204 where additional log data is accessed and subsequently processed accordingly. As noted above, operations 212 and 214 are illustrated using dashed boxes to indicate that, in some examples, they may be omitted. Thus, a model need not be updated and/or provided to a parent node. In such examples, flow instead progresses from operations 208 or 210 to operation 204, where additional log data is accessed and processed according to the other operations of method 200.

FIG. 2B illustrates an overview of an example method 220 for aggregating and processing models within a CDN according to aspects described herein. In examples, aspects of method 220 are performed by a model manager, such as model manager 130 in FIG. 1A. Method 220 begins at operation 222, where an indication of a model is received. The indication may be received from a child node, such as gateway node 102 or 104 in FIG. 1A. In some examples, the node performs aspects of method 200 (e.g., operation 214), thereby causing the node to provide an indication of an updated model, which is received at operation 222. In examples, the indication comprises information relating to the model, such as one or more confidence scores and/or historical model performance, among other examples.

At operation 224, the model is stored in a data store, such as data store 126 in FIG. 1A. In some examples, the model is associated with metadata in the data store, such as an indication of the node from which the model was received, a type of computing functionality provided by the node, a service for which the node provides computing functionality, and/or at least a part of the additional information about the model that was received at operation 222, among other metadata. In some examples, the model is stored as a new or updated version of a pre-existing model in the data store. For example, if a node generated an updated model (e.g., as described above with respect to operation 212 in FIG. 2A), the updated model received at operation 222 is stored as a new version of the model accordingly. An arrow is illustrated between operations 224 and 222 to indicate that, in some examples, operations 222 and 224 are performed multiple times while models are aggregated from one or more nodes of the CDN.

Eventually, flow progresses to operation 226, where stored models are ranked. In examples, a set of models is determined according to one or more attributes. For example, models from nodes having a similar geographic location, providing similar computing functionality, and/or that provide computing functionality for the same service or similar services. The set of models are ranked according to one or more model performance metrics, including, but not limited to, prediction accuracy or average confidence score. In examples where multiple metrics are used, each metric may be weighted in order to generate a score for the model.

At operation 228, a model is selected from the set of ranked models. In examples, selecting a model comprises selecting the highest-ranked model according to the ranking performed at operation 226. In other examples, multiple models may be selected from the ranked set of models, as may be the case when multiple models with which to process log data are provided to a node. While example ranking and selection techniques are described, it will be appreciated that any of a variety of other techniques may be used in other examples.

Moving to operation 230, an indication of the selected model is provided to a node. In examples, the indication is provided to a model processing engine of the node, such as model processing engine 118 or 124 in FIG. 1A. In some instances, the indication comprises an instruction to replace an existing model of the node with the indicated model (e.g., thereby updating a model of the node) or to remove one or more models. In some examples, the indication comprises an association with a specific service, computing functionality, or other instance in which the model should be used to process log data. Thus, the model need not be used by the node to process log data in all instances, but may instead by associated with one or more specific instances in which the model is well-suited to process such log data. Flow terminates at operation 230.

While method 200 is described in the context of a CDN node, it will be appreciated that similar techniques may be used for a model processing engine at a client computing device, such as model processing engine 138 of client computing device 110 in FIG. 1A. For example, a model is received from a node with which the client computing device is communicating, after which the model processing engine access and processes the log data accordingly. Any model processing result or updated model may be communicated back to the node of the CDN. In other examples, rather than communicating directly with the CDN, the client computing device communicates via a service, such as service 108 in FIG. 1A.

FIG. 2C illustrates an overview of an example method 240 for generating a model based on service log data and CDN log data according to aspects described herein. In examples, aspects of method 240 are performed by a model manager, such as model manager 130 in FIG. 1A. Model 240 begins at operation 242, where service log data is received from a service, such as service 108 in FIG. 1A. In some examples, the service transmits the log data such that it is received at operation 242 or, in other examples, the log data is requested or otherwise accessed from the service. For example, the service may provide an Application Programming Interface (API) with which the service log data can be accessed. It will be appreciated that while method 240 is described with respect to using service log data and CDN log data for model generation, any of a variety of other data sources may be used in addition to or as an alternative to log data from a service.

At operation 244, CDN log data is accessed. In examples, CDN log data is accessed from within a node (e.g., gateway node 102 or 104 in FIG. 1A) itself or may be accessed from a data store of a parent node (e.g., data store 126 of regional node 106), among other examples. As described above, the CDN log data may comprise information relating to system performance, system errors, CDN cache performance, and/or requests from client computing devices, among other information.

Flow progresses to operation 246, where the service log data and CDN log data is processed to generate a model. In examples, a statistical model is generated, wherein one or more thresholds or ranges that are indicative of normal or routine behavior (e.g., relating to resource utilization, requests per second, cache performance, time to process a request, etc.) are identified, such that subsequent log data that exceeds such a threshold or range is classified accordingly. In other examples, a machine learning model is generated to correlate events of the service log data with the CDN log data, thereby enabling the classification of subsequent CDN log data without additionally requiring service log data. The correlation may be identified automatically (e.g., based on timestamps, matching device identifiers, etc.) or based on annotations, or any combination thereof, among other examples. Such aspects may be useful in instances where the service does not provide access to the service log data contemporaneously with the generation and/or processing of the CDN log data. The machine learning model may be generated according to supervised or unsupervised learning techniques, among other examples. It will be appreciated that while operation 246 is described as generating a new model, similar techniques may be used to update an existing model.

Moving to operation 248, an indication of the selected model is provided to a node. In examples, the indication is provided to a model processing engine of the node, such as model processing engine 118 or 124 in FIG. 1A. In some instances, the indication comprises an instruction to replace an existing model of the node with the indicated model (e.g., thereby updating a model of the node) or to remove one or more models. In some examples, the indication comprises an association with a specific service, computing functionality, or other instance in which the model should be used to process log data. Thus, the model need not be used by the node to process log data in all instances, but may instead by associated with one or more specific instances in which the model is well-suited to process such log data. Flow terminates at operation 248.

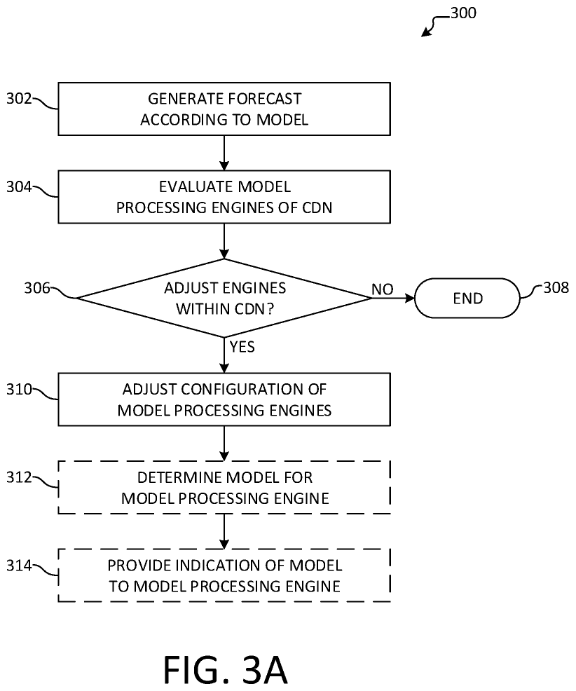

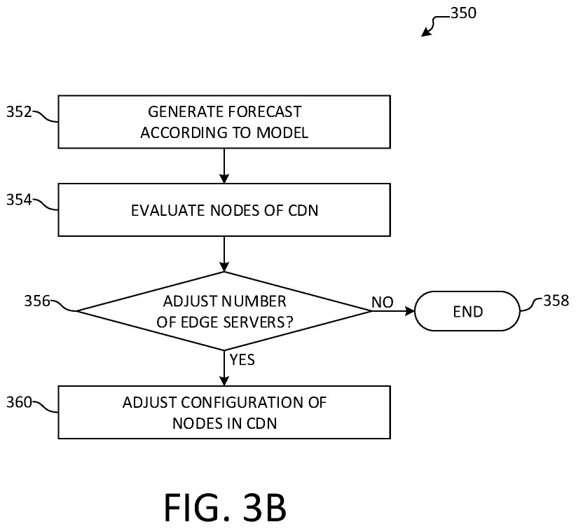

FIG. 3A illustrates an overview of an example method 300 for adapting model processing engines of a CDN based on a forecast according to aspects described herein. In examples, aspects of method 300 are performed by an infrastructure manager, such as infrastructure manager 128 in FIG. 1A. Method 300 may be performed periodically (e.g., weekly, daily, hourly, etc.) or in response to the occurrence of a predetermined event (e.g., utilization exceeding a predetermined threshold, the amount of unprocessed log data exceeding a predetermined number of events, etc.), among other examples.

Method 300 begins at operation 302, where a forecast is generated according to a model. In examples, the model used at operation 302 was generated by a model manager, such as model manager 130 in FIG. 1A. In other examples, the model may have been received from a model processing engine of a node, such as model processing engine 118 or 124 in FIG. 1A. The forecast may be generated based on one or more model processing results and associated log data, as may be stored by a data store such as data store 126 in FIG. 1A. In examples, the model used at operation 302 forecasts the quantity of log data that may be generated by one or more nodes of a CDN (such as gateway nodes 102 and/or 104).

Flow progresses to operation 304, where the computing capability of model processing engines within the CDN are evaluated based on the generated forecast. In examples, the evaluation comprises identifying nodes at which the model processing engines are collocated, how model processing engines are distributed within the CDN, and which nodes/how many nodes for which each model processing engine is responsible. As another example, the evaluation comprises determining the rate at which a model processing engine is able to process log data from the one or more nodes for which it is responsible.

At determination 306, it is determined whether to adjust the configuration of model processing engines within the CDN. In examples, the determination comprises comparing the forecast generated at operation 302 to the evaluation performed at operation 304 to determine whether the configuration of model processing engines is capable of meeting the forecasted demand. For example, a forecasted quantity of log data may be compared to a determined rate at which one or more model processing engines of the CDN is capable of processing log data. In examples, a buffer percentage is used in order to maintain a margin of error by which the forecasted quantity can vary while not exceeding the processing capability of the model processing engines. As another example, the determination comprises evaluating the available bandwidth to transmit the forecasted amount of log data to a model processing engine, as may be the case when a model processing engine is shared between multiple nodes. It will be appreciated that any of a variety of other techniques may be used to compare the generated forecast to the processing capacity of the CDN.

If it is determined not to adjust the configuration of model processing engines within the CDN, flow branches “NO” to operation 308, where method 300 ends. If, however, it is determined to adjust the configuration of model processing engines, flow instead branches “YES” to operation 310, where the configuration of model processing engines within the CDN is adjusted. In examples, operation 310 comprises provisioning a computing device or instantiating a new virtual machine in order to add a model processing engine at a node of the CDN. In another example, operation 310 comprises shutting down a computing device or suspending or otherwise stopping a virtual machine in order to remove a model processing engine from the CDN. In some instances, operation 310 comprises adjusting the amount or type of computing resources that are available to a virtual machine (e.g., number of processor cores, memory, type or quantity of storage, etc.). The actions described with respect to operation 310 may be performed by the infrastructure manager or, in other examples, an indication of such actions is generated and provided to a node of the CDN, after which the node performs the actions. Any of a variety of other techniques may be used to adjust the configuration of model processing engines within the CDN. Operations 312 and 314 are illustrated using dashed boxes to indicate that, in some examples, method 300 terminates at operation 310.

In other examples, flow progresses to operation 312, where a model is determined for a model processing engine, as may be the case when a model processing engine was added to the CDN at operation 310. In examples, the determination comprises performing aspects of method 220 in FIG. 2B or method 240 in FIG. 2C. The model may be a pre-existing model that is selected from a data store based on an evaluation of attributes associated with the model processing engine and/or an associated node, including, but not limited to, a geographic location, provided computing functionality, and/or one or more associated services.

Moving to operation 314, an indication of the determined model is provided to the model processing engine. In some examples, the indication comprises an association with a specific service, computing functionality, or other instance in which the model should be used to process log data. Thus, the model need not be used to process log data in all instances, but may instead by associated with one or more specific instances in which the model is well-suited to process such log data. Flow terminates at operation 314.

FIG. 3B illustrates an overview of an example method 350 for adapting a number of edge servers of a CDN based on a forecast according to aspects described herein. In examples, aspects of method 350 are performed by an infrastructure manager, such as infrastructure manager 128 in FIG. 1A. Method 350 may be performed periodically (e.g., weekly, daily, hourly, etc.) or in response to the occurrence of a predetermined event (e.g., utilization exceeding a predetermined threshold, the failure of an existing edge server in a node, etc.), among other examples.

Method 350 begins at operation 352, where a forecast is generated according to a model. In examples, the model used at operation 352 was generated by a model manager, such as model manager 130 in FIG. 1A. In other examples, the model may have been received from a model processing engine of a node, such as model processing engine 118 or 124 in FIG. 1A. The forecast may be generated based on one or more model processing results and associated log data, as may be stored by a data store such as data store 126 in FIG. 1A. In examples, the model used at operation 352 forecasts demand for computing resources of the CDN from client computing devices (e.g., client computing device 110 in FIG. 1A) and/or services (e.g., service 108).

Flow progresses to operation 354, where the computing capability of nodes of the CDN are evaluated based on the generated forecast. In examples, the evaluation comprises evaluating the number of edge servers of a node, computing functionality provided by such edge servers, and/or what data is stored in one or more caches of the node, among other examples. As another example, the evaluation comprises determining the rate at which one or more edge servers of a node are able to process requests of client computing devices and/or the bandwidth available to provide content in response to such requests.

At determination 356, it is determined whether to adjust the configuration of edge servers within the CDN. In examples, the determination comprises comparing the forecast generated at operation 352 to the evaluation performed at operation 354 to determine whether the configuration of edge servers is capable of meeting the forecasted demand. For example, a forecasted traffic may be compared to the evaluated computing functionality of one or more edge servers of the CDN. In examples, a buffer percentage is used in order to maintain a margin of error by which the forecasted traffic can vary while not exceeding the processing capability of the edge servers. It will be appreciated that any of a variety of other techniques may be used to compare the generated forecast to the processing capacity of the CDN.

If it is determined not to adjust the configuration of edge servers within the CDN, flow branches “NO” to operation 358, where method 350 ends. If, however, it is determined to adjust the configuration of edge servers, flow instead branches “YES” to operation 360, where the configuration of edge servers within the CDN is adjusted. In examples, operation 360 comprises provisioning a computing device or instantiating a new virtual machine in order to add an edge server at a node of the CDN. In another example, operation 360 comprises shutting down a computing device or suspending or otherwise stopping a virtual machine in order to remove an edge server from the CDN. In some instances, operation 360 comprises adjusting the amount or type of computing resources that are available to a virtual machine (e.g., number of processor cores, memory, type or quantity of storage, etc.). The actions described with respect to operation 360 may be performed by the infrastructure manager or, in other examples, an indication of such actions is generated and provided to a node of the CDN, after which the node performs the actions. Any of a variety of other techniques may be used to adjust the configuration of edge servers within the CDN. Method 350 terminates at operation 360.

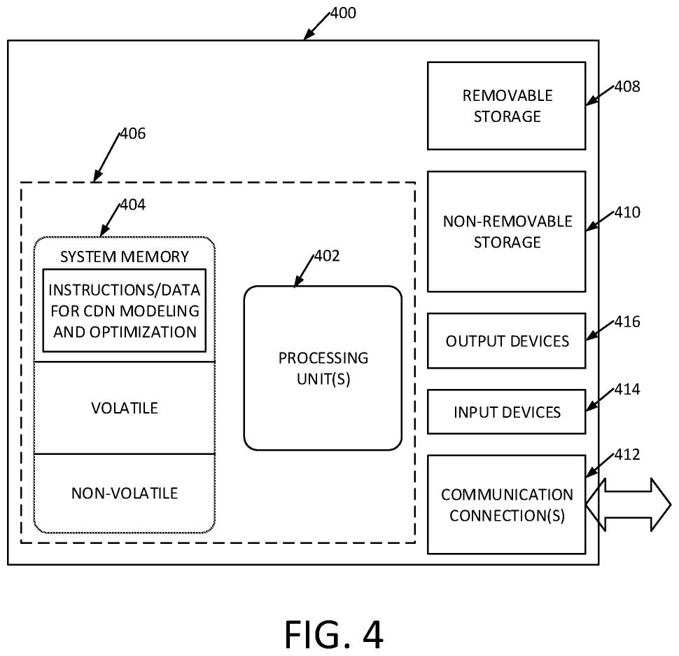

FIG. 4 illustrates an example of a suitable operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically may include at least one processing unit 402 and memory 404. Depending on the exact configuration and type of computing device, memory 404 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as a keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 may include at least some form of computer readable media. The computer readable media may be any available media that can be accessed by processing unit 402 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 404. While executing on the processing unit 402, program modules (e.g., applications, Input/Output (I/O) management, and other utilities) may perform processes including, but not limited to, one or more of the stages of the operational methods described herein such as the methods illustrated in FIGS. 2A-2C and 3A-3B, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 400 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

This disclosure described some aspects of the present technology with reference to the accompanying drawings, in which only some of the possible embodiments were shown. Other aspects may, however, be embodied in many different forms and should not be construed as limited to the embodiments set forth herein. Rather, these aspects were provided so that this disclosure was thorough and complete and fully conveyed the scope of the possible embodiments to those skilled in the art.

Although specific aspects were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A system comprising:
at least one processor; and
memory, operatively connected to the at least one processor and storing instructions that, when executed by the at least one processor, cause the system to perform a set of operations, the set of operations comprising:
accessing log data associated with a node of a content distribution network (CDN), wherein the log data comprises a plurality of events associated with a computing device of the node;
processing, at the node, the log data using a model to generate a model processing result, wherein the model processing result is associated with a subset of the log data;
generating, at the node, an indication of the model processing result; and
providing the indication to a parent node of the node.

2. The system of claim 1, wherein the set of operations further comprises:
receiving, from the parent node in response to the indication, an action to perform at the node based on the model processing result.

3. The system of claim 1, wherein the indication of the model processing result comprises at least one of:
the subset of the log data;
an identifier associated with the node; or
an identifier associated with the computing device of the node.

4. The system of claim 1, wherein the set of operations further comprises:
receiving, from the parent node, the model to process log data of the node.

5. The system of claim 1, wherein the set of operations further comprises:
generating the model based at least in part on historical log data of the node.

6. The system of claim 5, wherein the model is generated further based on service log data from a service that is a customer of the CDN.

7. The system of claim 1, wherein the model is a first model, the model processing result is a selected model processing result, and wherein processing the log data to generate the model selected processing result comprises:
processing, at the node, the log data using the first model to generate a first model processing result;
processing, at the node, the log data using a second model to generate a second model processing result; and
selecting the selected model processing result from the first model processing result and the second model processing result based at least in part on:
a first model performance metric of the first model; and
a second model performance metric of the second model.

8. A method for processing models of a content distribution network (CDN), the method comprising:
receiving, from a first node of the CDN, a first model;
receiving, from a second node of the CDN, a second model;
ranking the first model and the second model based at least in part on a model performance metric to identify a highest-ranked model; and
providing an indication of the highest-ranked model to a third node of the CDN.

9. The method of claim 8, wherein the indication of the highest-ranked model is provided to the third node of the CDN based at least in part on determining that the first node, the second node, and the third node have at least one similar attribute.

10. The method of claim 8, further comprising:
accessing service log data associated with a service that is a customer of the CDN;
accessing CDN log data associated with the first node of the CDN;
generating, based at least in part on the service log data and the CDN log data, a machine learning model; and
providing an indication of the machine learning model to a node of the CDN.

11. The method of claim 10, wherein at least one of the service log data or the CDN log data is annotated to indicate a correlation between the service log data and the CDN log data.

12. The method of claim 8, wherein the service log data comprises log data generated by a model processing engine of a client computing device.

13. The method of claim 8, wherein the first node is the second node, and wherein the third node is a different node than the first node and second node.

14. A method for managing a configuration of a content distribution network (CDN), the method comprising:
generating, based at least in part on a model and a model processing result, a forecast for demand of the CDN, wherein the model processing result was received from a node of the CDN;
evaluating, based at least in part on the generated forecast, a computing capability of the node of the CDN to determine whether to change the configuration of the CDN; and
based on the determining to change the configuration of the CDN:
generating an operation to change the configuration of the CDN based on the generated forecast and the computing capability; and
providing, to the node, an indication of the generated operation.

15. The method of claim 14, wherein:
the forecast is associated with log data of the CDN; and
the computing capability of the node relates to a model processing engine to process the log data.

16. The method of claim 15, wherein the operation to change the configuration of the CDN is adding a new model processing engine to the node of the CDN, and wherein the method further comprises:
determining a model for the new model processing engine; and
providing an indication of the model to the new model processing engine.

17. The method of claim 16, wherein the operation comprises an instruction to instantiate a virtual machine as the new model processing engine.

18. The method of claim 14, wherein:
the forecast is associated with demand for computing functionality of the CDN; and
the computing capability of the node relates to a set of edge servers of the node.

19. The method of claim 14, wherein the computing capability is evaluated based at least in part on a buffer percentage.

20. The method of claim 14, comprising receiving the model to generate the forecast from a parent node.
